(19) United States
(12) Patent Application Publication
(10) Pub. No.: US 2025/0198075 A1
(43) Pub. Date: Jun. 19, 2025

(54) PRESSURE SENSITIVE PASSIVE LAUNDRY MICROPLASTIC FILTRATION

(71) Applicant: WHIRLPOOL CORPORATION, Benton Harbor, MI (US)

(72) Inventor: Muhammad KHIZAR, St. Joseph, MI (US)

(21) Appl. No.: 18/541,934

(22) Filed: Dec. 15, 2023

(51) Int. Cl. D06F 39/10; B01D 37/02

(52) U.S. Cl. CPC D06F 39/10; B01D 37/025; B01D 2221/02

(57) ABSTRACT

This disclosure relates to a laundry appliance having a cylindrical drum rotating about an axis, equipped with a clothes mover with a pressure-sensitive material. This material may comprise a blend of ceramic grinding beads and transition metal or lanthanide-stabilized zirconium materials coated with poly(2-ethylhexyl acrylate), which adheres to microplastics present in laundry items and water. The drum of the laundry appliance may include a curved portion and a rear wall portion, providing a receptacle for laundry processing, while the clothes mover captures microplastics during the laundry cycle.

### TECHNICAL FIELD

The present application is directed to a laundry appliance, and more particularly, to filtering microplastics from water in the drum of the laundry appliance.

### BACKGROUND

Laundry appliances, such as clothes washers, dryers, refreshers, and non-aqueous systems, may include a rotating drum (or basket) for receiving items to be laundered. The drum is housed in an appliance body, where the body has a door for providing access to the drum. The laundry appliance may be a front-loading washer or a top-loading washer, such that the drum is positioned on a horizontal rotational axis or vertical rotational axis, respectfully. The drum is rotated by a motor, and the drum may include lifters or an agitator to facilitate movement and cleaning and/or drying of the clothing items within the drum. The laundry appliance may include a controller that operates the laundry appliance based on a user-input selection of numerous pre-programmed cycles. Each pre-programmed cycle may have various adjustable parameters (e.g., time, temperature, etc.) which may be adjusted by the user. Upon loading of laundry items in the drum, and selection of the pre-programmed cycle (and any adjustments therein), the laundry appliance operates to treat the laundry items based on the type of appliance (i.e., a washer runs the selected wash cycle, the dryer runs the selected dry cycle, etc.).

### SUMMARY

A laundry appliance comprises a cylindrical drum that is rotatable about a horizontal axis, with the drum including a wall that defines a receptacle for receiving laundry items and water. A pressure-sensitive coating applied to the lifter's surface comprises a fused ceramic grinding bead combination, which consists of cerium-stabilized zirconium oxide and yttrium-stabilized zirconium silicate. The pressure-sensitive coating becomes adhesive in a humidity range of 60% to 95%. The pressure-sensitive coating on the laundry appliance may be configured to lose its adhesiveness at a humidity level below 50%. The thickness of the pressure-sensitive coating on the laundry appliance's lifter ranges from 0.1 to 5 millimeters. In some configurations, laundry appliance features a lifter that is removable, allowing for easy cleaning and maintenance of the pressure-sensitive coating. The pressure-sensitive coating may be integrated into the base material of the lifter.

In another embodiment, an appliance comprises a cylindrical drum rotatable about a vertical axis, including an agitator within the receptacle that contacts laundry items and water. A pressure-sensitive coating on the agitator includes a fused ceramic grinding bead combination having cerium-stabilized zirconium oxide and yttrium-stabilized zirconium silicate.

The pressure-sensitive coating is configured to become adhesive in a humidity range of 60% to 95%. This coating may be designed to lose its adhesiveness at a humidity level below 50%. The thickness of the pressure-sensitive coating on the agitator may range from 0.1 to 5 millimeters. The agitator may be designed for easy removal and reattachment. In some configurations the pressure-sensitive coating may integrated into the base material of the agitator.

In another configuration, a laundry appliance having at least one pressure-sensitive material-based clothes mover, comprising a fused ceramic grinding bead combination of two or more transition metal or lanthanide-stabilized zirconium materials coated with poly(2-ethylhexyl acrylate), that adheres microplastics from laundry items and water during a laundry cycle. This appliance's clothes mover may be specifically a lifter. Alternatively, the clothes mover in this appliance may be an agitator. The pressure-sensitive material-based clothes mover may include a fused ceramic grinding bead combination featuring cerium-stabilized zirconium oxide and yttrium-stabilized zirconium silicate. The material-based clothes mover in the appliance may be configured to become adhesive in a humidity range of 60% to 95%. The clothes mover may lose its adhesiveness at a humidity level below 50%.

### BRIEF DESCRIPTION OF THE DRAWINGS

FIG. 1 is a perspective view of a front-load laundry appliance, according to various embodiments;

FIG. 2 is a perspective view of the drum and components of the laundry appliance of FIG. 1;

FIG. 3 is a schematic view of a top-load laundry appliance, according to various embodiments; and

FIG. 4 is a perspective view of an agitator, according to various embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Microplastics are now ubiquitous in the environment and are found in all surface water, including in city water used for home as well as commercial laundry. Laundry appliances are a source of microplastics being added to our water reservoir ecosystems. While efforts to remove large plastic items from the environment have been ongoing, comparatively little has been done to address microplastic pollution for laundry machines. Thus, according to various embodiments, a passive solution to address microplastics in laundry appliances more efficiently and effectively is provided. The passive solution allows for microplastic filtration from the laundry grey water without any dependency on extra power or digital resources.

Conventional microplastic filtration solutions are expensive to implement in laundry appliances, and come with difficulty in obtaining HEPA compliance and adhering to collected waste disposal protocols. Given the small footprints of the laundry drum for any filtration system installation, and the drums being rotating parts, it poses an extra challenge to the throughput and integrity of conventional filtration solutions. Thus, the passive solution of the present application does not require any extra space or external power for its operation.

According to one or more embodiments, a laundry appliance includes a drum having one or more surfaces with a pressure-sensitive coating thereon. The one or more surfaces may be the lifters of the drum (i.e., in front load appliances) or on the agitator (i.e., in top load appliances). The pressure-sensitive coating upon application adhere microplastics from laundry gray water thereto to filter and remove microplastics from the laundry gray water. Upon completion of the wash cycle, the lifters and/or agitator may be wiped off to remove the microplastics. Thus, the pressure-sensitive coating is selectively adherent for microplastics in the high humidity environment (i.e., when the wash cycle is running such that gray water is in direct contact with the lifter and/or agitator or in an environment of at least 60% humidity), and upon drying and lower humidity levels (e.g., ambient humidity), the pressure-sensitive coating may be cleaned of the microplastics by a user.

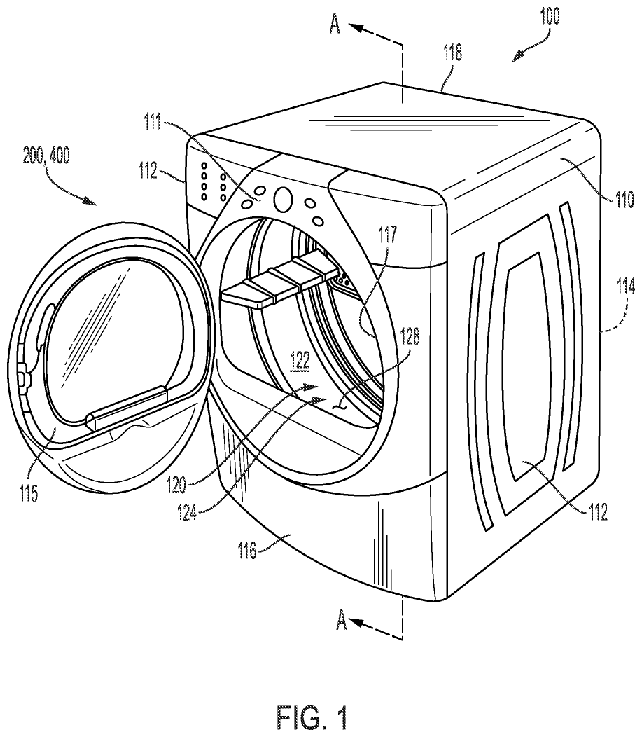

FIG. 1 illustrates a schematic view of a laundry treating appliance 100 according to aspects of the present disclosure. The laundry treating appliance 100 may be any laundry treating appliance 100 that performs a cycle of operation to clean or otherwise treat laundry items placed therein, non-limiting examples of which include a horizontal or vertical axis clothes washer; a clothes dryer; a combination washing machine and dryer; a dispensing dryer; a tumbling or stationary refreshing/revitalizing machine; an extractor; a non-aqueous washing apparatus; and a revitalizing machine. While the laundry treating appliance 100 is illustrated herein as a vertical axis, top-load laundry treating appliance 100, the aspects of the present disclosure may have applicability in laundry treating appliances with other configurations. The laundry treating appliance 10 shares many features of a conventional automated clothes washer and/or dryer, which will not be described in detail herein except as necessary for a complete understanding of the exemplary aspects in accordance with the present disclosure.

Laundry treating appliances are typically categorized as either a vertical axis laundry treating appliance or a horizontal axis laundry treating appliance. As used herein, the term “horizontal axis” laundry treating appliance refers to a laundry treating appliance having a rotatable drum that rotates about a generally horizontal axis relative to a surface that supports the laundry treating appliance. The drum may rotate about the axis inclined relative to the horizontal axis, with fifteen degrees of inclination being one example of the inclination. Similar to the horizontal axis laundry treating appliance, the term “vertical axis” laundry treating appliance refers to a laundry treating appliance having a rotatable drum that rotates about a generally vertical axis relative to a surface that supports the laundry treating appliance. However, the rotational axis need not be perfectly vertical to the surface. The drum may rotate about an axis inclined relative to the vertical axis, with fifteen degrees of inclination being one example of the inclination.

In another aspect, the terms vertical axis and horizontal axis are often used as shorthand terms for the manner in which the appliance imparts mechanical energy to the laundry, even when the relevant rotational axis is not absolutely vertical or horizontal. As used herein, the “vertical axis” laundry treating appliance refers to a laundry treating appliance having a rotatable drum, perforate or imperforate, that holds fabric items and, optionally, a clothes mover, such as an agitator, impeller, nutator, and the like within the drum. The clothes mover may move within the drum to impart mechanical energy directly to the clothes or indirectly through wash liquid in the drum. The clothes mover may typically be moved in a reciprocating rotational movement. In some vertical axis laundry treating appliances, the drum rotates about a vertical axis generally perpendicular to a surface that supports the laundry treating appliance. However, the rotational axis need not be vertical. The drum may rotate about an axis inclined relative to the vertical axis.

As used herein, the “horizontal axis” laundry treating appliance refers to a laundry treating appliance having a rotatable drum, perforated or imperforate, that holds laundry items and washes and/or dries the laundry items. In some horizontal axis laundry treating appliances, the drum rotates about a horizontal axis generally parallel to a surface that supports the laundry treating appliance. However, the rotational axis need not be horizontal. The drum may rotate about an axis inclined or declined relative to the horizontal axis. In horizontal axis laundry treating appliances, the clothes are lifted by the rotating drum and then fall in response to gravity to form a tumbling action. Mechanical energy is imparted to the clothes by the tumbling action formed by the repeated lifting and dropping of the clothes. Vertical axis and horizontal axis machines are best differentiated by the manner in which they impart mechanical energy to the fabric articles.

Regardless of the axis of rotation, a laundry treating appliance may be top-loading or front-loading. In a top-loading laundry treating appliance, laundry items are placed into the drum through an access opening in the top of a cabinet, while in a front-loading laundry treating appliance laundry items are placed into the drum through an access opening in the front of a cabinet. If a laundry treating appliance is a top-loading horizontal axis laundry treating appliance or a front-loading vertical axis laundry treating appliance, an additional access opening is located on the drum.

The front-loading vertical axis laundry treating appliance 100 includes an outer appliance body 110 defining the outer cabinet structure of the laundry appliance 100. The body 110 is constructed of side walls 112, rear wall 114, front surface 116, and top surface 118. The body 110 further includes a control panel 111. Although shown on the front surface 116 in FIG. 1, the control panel 111 may be located in any convenient position such that a user may select the operation cycles of the laundry appliance (e.g., on top surface 118 or on a flange extending from the top surface 118 or the front surface 116). The laundry appliance 100 further includes a door 115 for providing access inside the cavity defined by the body 110 via an opening 117 in the front surface 116. The door 115 may be hinged and mounted to the front surface 116, such that it may be engaged with the body 110 to seal the cavity at the opening 117. The laundry appliance 100 further includes a drum 120 for receiving laundry items (e.g., clothing, towels, linens, and the like) and laundry gray water in the cavity of the body 110, although not visible in FIG. 1. The drum 120 defines an interior receptacle 122 where the laundry items are placed, with the receptacle 122 being accessible via the opening 117, such that a user may open the door 115 to place the laundry items within the receptacle 122. When the door 115 is closed, the interior receptacle 122 is sealed from the external environment by the door 115 to reduce leaks (e.g., air or water) from the opening 117 during a laundry cycle. A portion of the door 115 may be sufficiently transparent such that the laundry items within the receptacle 122 may be seen through the door 115.

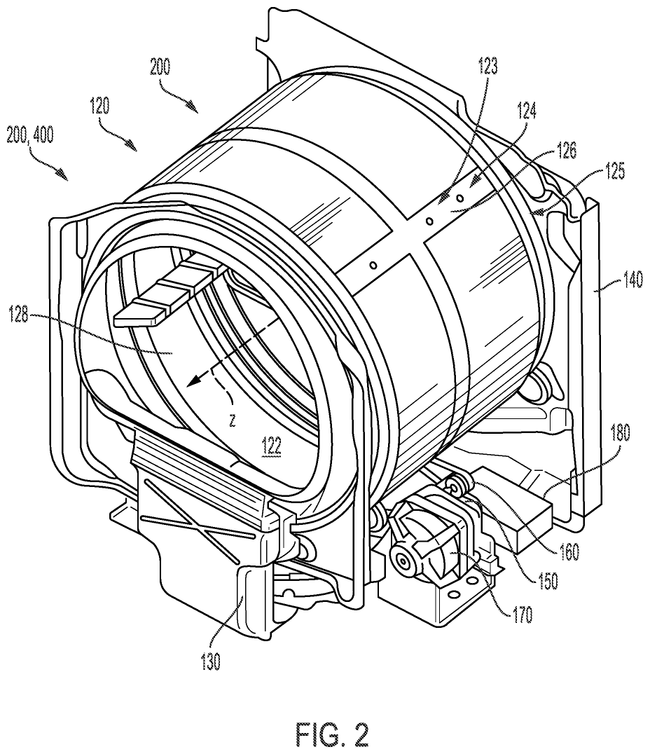

Referring to FIG. 2, the laundry appliance 100 is shown with the outer body 110 removed. As can be more clearly seen in FIG. 2, the drum 120 is constructed of a drum wall 124 defining an outer surface 126 and an inner surface 128 defining the receptacle 122 for the laundry items. The drum 120 is generally cylindrical in shape, with the drum wall 124 including a curved portion 123 such that receptacle 122 has a substantially circular cross section. The receptacle 122 is open for access on one end, toward the front surface 116 of the laundry appliance 100, and may include a rear base wall, or rear portion, 125 toward the rear of the drum 120. The curved portion 123 of the drum wall 120 defines the opening 117, and the rear base wall 125 forms the back of the receptacle (i.e., the base of the cylindrical drum), such that the inner surface 128 defines the receptacle 122 for the laundry items and gray water.

The drum 120 may be mounted within the appliance body 110 in any suitable manner, such as, for example, via front and rear mounting panels 130, 140. The drum 120 is rotatable about a central axis Z via any suitable mechanism, shown as a motor 150 which is connected to a drive belt 160 on the outer surface 126 of the drum wall 124. Rotation of the drum 120 tumbles the laundry items to aid in or washing of the laundry items within the receptacle 122. The inner surface 128 includes lifters 200 extending from the inner surface 128 into the receptacle 122 to facilitate movement and tumbling of the laundry items within the receptacle 122 during a laundry cycle. The lifters 200 include surfaces 210 which contact the laundry items and/or gray water in the receptacle during a laundry cycle. The design and shape of the lifters 210 may be chosen to optimize the tumbling and movement of clothing, as well as to increase surface contact with clothing and water.

The laundry appliance 100 includes additional components as shown in FIG. 2 as required for operation of the laundry appliance, such as, but not limited to a pump assembly 170 for supplying water into and/or removing water from the receptacle 122 of the drum 120, a heater assembly (not shown) for heating the water, and a controller 180 for operating the pump assembly 170 and/or the heater assembly according to the user input. The pump and heater assemblies may be any suitable assemblies for providing heated water to the drum 120. Water may be drained from the receptacle 122 of drum 120 via drain passages (not shown). In embodiments where the drum 120 is part of a dryer, the dryer may include suitable components for supplying air into and/or removing air from the receptacle 122 of the drum 120, and for heating the air according to the user input and selected laundry cycle.

In one aspect of the invention, the laundry appliance 100 includes a pressure-sensitive coating 400 disposed on various relevant surfaces. These surfaces are typically selected based on their frequency and type of contact with the laundry items and gray water. For example, in top-loading laundry appliances, the pressure-sensitive coating 400 may be primarily applied to areas of the lifter 200 that are most likely to come into contact with laundry items and gray water. The types of microplastics targeted for removal include, but are not limited to, biodegradable Styrofoam microplastics, polystyrene, nylon, rubber, nonpolar polymers (e.g., polyethylene, micronized rubber) and polar polymers (e.g., nylon, polyethylene terephthalate).

For cleaning off the adhered microplastics, the user can simply wipe the coated surfaces. In embodiments where the lifter 200 or an agitator is removable, these components may be detached and washed separately to remove any accumulated microplastics. The pressure-sensitive coating 400 exhibits specific properties that may increase its functionality. Its thickness ranges from about 0.1 to 5 millimeters, and it is formulated to become activated in the presence of humidity, particularly within a range of 60% to 95%. This humidity activation allows the coating to become adhesive when in contact with wet laundry and gray water, thereby enabling effective microplastic adhesion.

Specifically, the pressure-sensitive coating 400 is composed of a unique fused ceramic grinding bead combination. This combination includes two or more materials, such as cerium-stabilized zirconium oxide and yttrium-stabilized zirconium silicate, which are coated with poly(2-ethylhexyl acrylate). The selection of these materials is based on their ability to adhere to microplastics while maintaining structural integrity during laundry cycles. The effectiveness of the pressure-sensitive coating 400 in removing microplastics may be optimized by material selection. The coating 400 may remove up to 99% of the microplastics during a laundry cycle, with significant removal efficiency observed within 5-7 minutes of contact with gray water. This efficiency may be maintained across a range of adhesive molar masses, from 92-988 kg/mol, as demonstrated in tests quantified by flow cytometry.

Hence, surfaces 210, 310 of the laundry appliance 100, when coated with the pressure-sensitive coating 400, may effectively adhere microplastics suspended in laundry gray water or from wet clothes in a high humidity environment upon contact. By applying this coating 400 to laundry lifters 200 and clothes movers 300, and facilitating its extraction by a user, the invention provides a passive and low-profile solution for concentrating and removing microplastics from the laundry gray water.

While the pressure-sensitive coating 400 is described as being applied to selective surfaces, it may also be integrated into the base material of components such as the lifter 200 and/or an agitator. This integration allows the appliance to maintain the surface effect of the coating while potentially offering improved durability and ease of manufacturing.

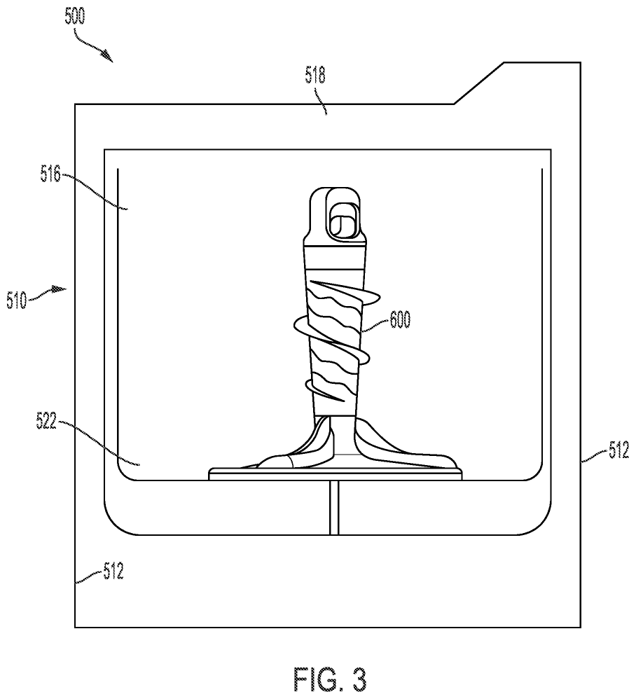

FIG. 3 illustrates a schematic view of a top-loading horizontal axis laundry treating appliance 500 includes an outer appliance body 510 defining the outer cabinet structure of the laundry appliance 500. The body 510 is constructed of side walls 512, rear wall 514, interior surface 516, and top surface 518. The laundry appliance 500 further includes a drum 520 for receiving laundry items (e.g., clothing, towels, linens, and the like) and laundry gray water in the cavity of the body 510. The drum 520 defines a tub 522 where the laundry items are placed. Laundry items placed within the tub 522 are accessible via the opening 517.

A clothes mover 600 may be rotatably mounted within the tub 522 to impart mechanical agitation and energy to a load of laundry items placed in the tub 522 according to a cycle of operation. The clothes mover 600 may be oscillated or rotated about its vertical axis of rotation during a cycle of operation in order to produce load motion effective to wash the load contained within the tub 522.

The clothes mover 600 may comprise a base or an impeller 602, and a barrel, illustrated herein as an agitator 604. The agitator 604 as illustrated herein may comprise a vertically oriented agitator post 606 that may be removably coupled with the impeller 602, the agitator 604 projecting vertically from the impeller 602 within the tub 522 and toward the top surface 518. The agitator 604 may include any configuration of vanes, blades, or other structural features for imparting mechanical energy to laundry items during a cycle of operation. Generally, the vertical extent of the agitator 604, combined with vane, blade, or other structural features, may impart the mechanical action to laundry items, which provides improved cleaning performance and may be suitable for particularly soiled loads. Other exemplary types of clothes movers include, but are not limited to, an agitator alone, a wobble plate, and a hybrid impeller/agitator.

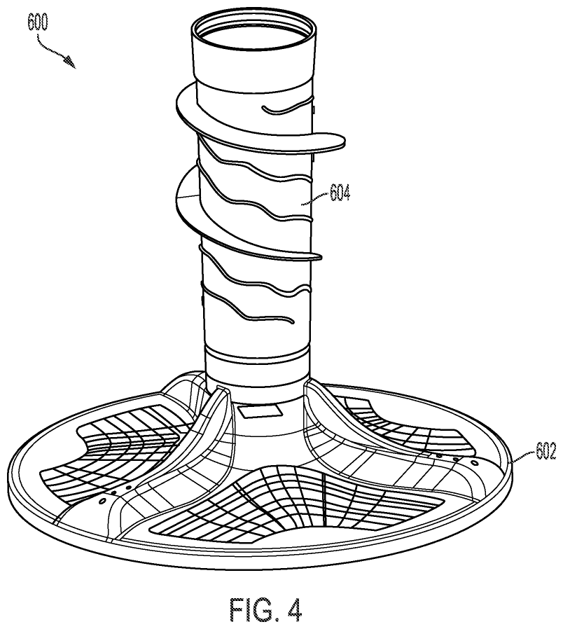

Referring now to FIG. 4, the agitator 604 may comprise pressure-sensitive material, described but not shown. In the construction of the agitator 604, transition metals and lanthanides, may be used. Stabilized zirconium materials, derived from these categories, may specifically be used. These materials may be formed into a grinding bead combination of two or more transition metal or lanthanide-stabilized zirconium materials. In some configurations the beads may further be coated with poly(2-ethylhexyl acrylate). The material's composition is configured to adhere to microplastics in the high-humidity environment typical of laundry cycles, particularly within a humidity range of 60% to 95%.

The agitator 604 may be configured to capture microplastics without affecting its primary washing function. The pressure-sensitive material used in its construction may have a thickness between 0.1 to 5 millimeters, providing a balance between microplastic capture and the mechanical flexibility and durability required for the agitator's operation. The agitator 604 loses its adhesiveness at humidity levels below 50%. This allows for easy cleaning after the laundry cycle. Users may remove accumulated microplastics by wiping or washing the agitator in a lower humidity environment, helping to maintain the appliance's efficiency and hygiene. In some configurations the agitator 604 may be designed the ability for easy removal and reattachment. The pressure-sensitive material may also be integrated into the base 602 of the agitator 604.

Incorporating pressure-sensitive materials into laundry appliance components may address microplastic pollution in laundry wastewater. These materials, including stabilized zirconium materials coated with poly(2-ethylhexyl acrylate), may ne used in parts like lifters and agitators to capture microplastics. The materials cane be effective in various humidity conditions.

The material may be integrated into different types of laundry appliances, including vertical and horizontal axis machines, enabling microplastic capture without compromising the appliance's primary function. The material's thickness balances microplastic capture with the appliance's mechanical requirements, and its ability to lose adhesiveness at lower humidity levels aids in cleaning. Contributing to a reduction of microplastic contamination.

Except where otherwise expressly indicated, all numerical quantities and ranges in this disclosure are to be understood as modified by the word “about.” Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

“One or more” includes a function being performed by one element, a function being performed by more than one element, e.g., in a distributed fashion, several functions being performed by one element, several functions being performed by several elements, or any combination of the above.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A laundry appliance comprising:
a cylindrical drum rotatable about a horizontal axis of rotation, the cylindrical drum including a drum wall defining a receptacle for receiving laundry items and water therein, the drum wall including a curved portion and a rear wall portion having an inner surface;
at least one lifter on the inner surface and extending into the receptacle, the lifter defining a surface in contact with the laundry items and the water; and
a pressure-sensitive coating applied to the surface of the lifter, the pressure-sensitive coating including a fused ceramic grinding bead combination of two or more transition metal or lanthanide-stabilized zirconium materials coated with poly(2-ethylhexyl acrylate), wherein the pressure-sensitive coating adheres microplastics from the laundry items and water during a laundry cycle.

2. The laundry appliance of claim 1 wherein the fused ceramic grinding bead combination includes cerium-stabilized zirconium oxide and yttrium-stabilized zirconium silicate.

3. The laundry appliance of claim 1 wherein the pressure-sensitive coating is configured to become adhesive in a humidity range of 60% to 95%.

4. The laundry appliance of claim 1 wherein the pressure-sensitive coating loses its adhesiveness at a humidity level below 50%.

5. The laundry appliance of claim 1 wherein the pressure-sensitive coating has a thickness ranging from 0.1 to 5 millimeters.

6. The laundry appliance of claim 1 wherein the lifter is removable, allowing for easy cleaning and maintenance of the pressure-sensitive coating.

7. The laundry appliance of claim 1 wherein the pressure-sensitive coating is integrated into a base material of the lifter.

8. A laundry appliance comprising:
a cylindrical drum rotatable about a vertical axis of rotation, the cylindrical drum including a drum wall defining a receptacle for receiving laundry items and water therein;
an agitator disposed within the receptacle, the agitator defining a surface in contact with the laundry items and the water; and
a pressure-sensitive coating applied to the surface of the agitator, the pressure-sensitive coating, including a fused ceramic grinding bead combination of two or more transition metal or lanthanide-stabilized zirconium materials coated with poly(2-ethylhexyl acrylate), wherein the pressure-sensitive coating adheres microplastics from the laundry items and water during a laundry cycle.

9. The laundry appliance of claim 8 wherein the fused ceramic grinding bead combination includes cerium-stabilized zirconium oxide and yttrium-stabilized zirconium silicate.

10. The laundry appliance of claim 8 wherein the pressure-sensitive coating is configured to become adhesive in a humidity range of 60% to 95%.

11. The laundry appliance of claim 8 wherein the pressure-sensitive coating loses its adhesiveness at a humidity level below 50%.

12. The laundry appliance of claim 8 wherein the pressure-sensitive coating has a thickness ranging from 0.1 to 5 millimeters.

13. The laundry appliance of claim 8 wherein the agitator is designed for easy removal and reattachment, allowing for easy cleaning and maintenance of the pressure-sensitive coating.

14. The laundry appliance of claim 8 wherein the pressure-sensitive coating is integrated into the base material of the agitator.

15. A laundry appliance comprising:
a cylindrical drum rotatable about an axis of rotation, the cylindrical drum including a drum wall defining a receptacle for receiving laundry items and water therein, the drum wall including a curved portion and a bottom portion having an inner surface; and
at least one pressure-sensitive material-based clothes mover, comprising a fused ceramic grinding bead combination of two or more transition metal or lanthanide-stabilized zirconium materials coated with poly(2-ethylhexyl acrylate), wherein the pressure-sensitive material-based lifter adheres microplastics from laundry items and water during a laundry cycle.

16. The laundry appliance of claim 15 wherein the clothes mover is a lifter.

17. The laundry appliance of claim 15 wherein the clothes mover is an agitator.

18. The laundry appliance of claim 15 wherein the fused ceramic grinding bead combination includes cerium-stabilized zirconium oxide and yttrium-stabilized zirconium silicate.

19. The laundry appliance of claim 15 wherein the pressure-sensitive material-based clothes mover is configured to become adhesive in a humidity range of 60% to 95%.

20. The laundry appliance of claim 15 wherein the pressure-sensitive material-based clothes mover loses its adhesiveness at a humidity level below 50%.
